(19) United States
(12) Patent Application Publication
(10) Pub. No.: US 2021/0302726 A1
(43) Pub. Date: Sep. 30, 2021

(54) HEAD MOUNTED DISPLAY

(71) Applicant: HTC Corporation, Taoyuan City (TW)

(72) Inventors: Bao-Jen Shih, Taoyuan City (TW); Bo-Wen Xiao, Taoyuan City (TW); Fu-Cheng Fan, Taoyuan City (TW)

(73) Assignee: HTC Corporation, Taoyuan City (TW)

(21) Appl. No.: 16/835,309

(22) Filed: Mar. 31, 2020

(51) Int. Cl. G02B 27/00; G02B 27/01; G06F 3/01

(52) U.S. Cl. CPC G02B 27/0093; G02B 2027/0138; G06F 3/013; G02B 27/0172

(57) ABSTRACT

A head mounted display includes a tube, a first light beam generator, a second light beam generator, an image capturer and a controller. The first light beam generator is disposed outside the tube and projects a plurality of first light beams to a first range of a target area. The second light beam generator is disposed inside the tube and projects a second light beam to a second range of the target area. The image capturer captures an image on the target area to generate image information. The controller receives the image information and performs an eye-tracking operation according to the image information. The second range is a center range of the target area, and the first range is a surrounding range of the target area.

### TECHNICAL FIELD

The invention relates to a head mounted display, and more particularly, to a head mounted display that can improve eye-tracking accuracy.

### BACKGROUND

With the advancement of electronic technology, head mounted displays that can provide high-dimensional display capability have become a new trend. The head mounted display can provide a variety of visual experiences such as virtual reality, augmented reality and mixed reality, and has made revolutionary contributions to applications in various fields.

In the technical field of head mounted displays, tracking the state of the user's eyeballs is an important issue. In the conventional technical field, a light beam can be projected onto the eyeball through a light emitting diode, and an eyeball tracking operation can be performed through a light spot reflected on the eyeball.

Due to difference head shapes of users, when wearing the head mounted display, a distance between the user's eyeball and an imaging lens of the head mounted display may be different for different users. In such a case, when the user's eyeball is too close to an imaging lens of the head mounted display, the light beam projected by the light emitting diode for tracking the eyeball may only be effectively irradiated to a partial range of the eyeball. As a result, in the case where the partial range is not effectively irradiated by the light beam, the accuracy of the eye-tracking operation performed may be greatly reduced, which reduces the performance of the head mounted display.

### SUMMARY

The invention provides a head mounted display capable of improving eye-tracking accuracy.

The head mounted display of the invention includes a tube, a first light beam generator, a second light beam generator, an image capturer and a controller. The first light beam generator is disposed outside the tube and projects a plurality of first light beams to a first range of a target area. The second light beam generator is disposed inside the tube and projects a second light beam to a second range of the target area. The image capturer captures an image on the target area to generate image information. The controller receives the image information and performs an eye-tracking operation according to the image information. The second range is a center range of the target area, and the first range is a surrounding range of the target area.

Based on the above, the head mounted display of the invention can project the light beams to the surrounding area and the center area of the target area through the different light beam generators respectively disposed outside and inside the tube. When the target area is too close to the tube, the second light beam generator can project the second light beam to the center range of the target area to increase a brightness of a light spot generated at the center range of the target area, so to improve eye-tracking accuracy.

### BRIEF DESCRIPTION OF THE DRAWINGS

FIG. 1 illustrates a side view of a head mounted display in an embodiment of the invention.

FIG. 2 illustrates a schematic diagram of a head mounted display in an embodiment of the invention.

FIG. 3A to FIG. 3D illustrate schematic diagrams of a supplementary lighting operation in an embodiment of the invention.

FIG. 4 illustrates a flowchart of the supplementary lighting operation of the head mounted display in an embodiment of the invention.

FIG. 5 illustrates a schematic diagram of image information in an embodiment of the invention.

FIG. 6 illustrates a flowchart of an eye-tracking function of the head mounted display in an embodiment of the invention.

FIG. 7 illustrates a schematic diagram of a calculating method for a curvature of a cornea of an eyeball and a distance between the eyeball and a lens.

### DESCRIPTION OF THE EMBODIMENTS

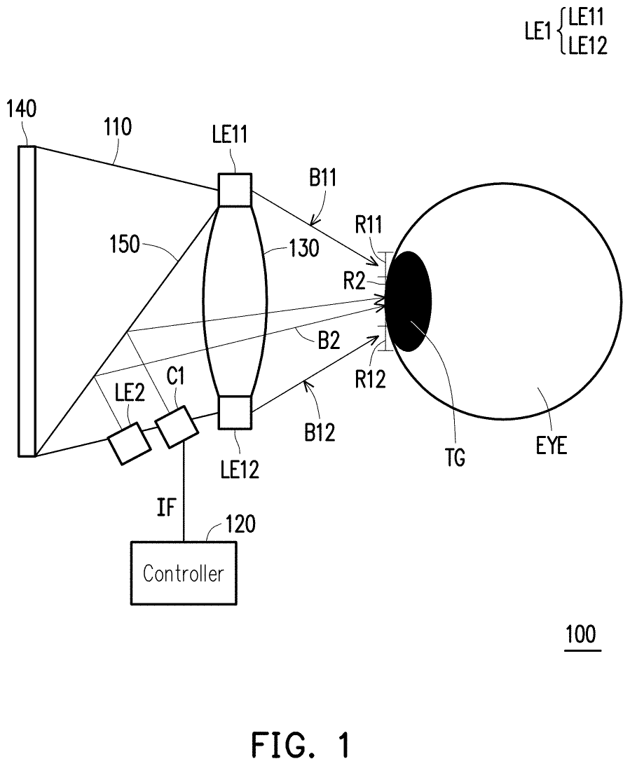

Referring to FIG. 1, FIG. 1 illustrates a side view of a head mounted display in an embodiment of the invention. A head mounted display 100 includes a tube 110, light beam generators LE1 and LE2, an image capturer C1, a controller 120, a lens 130 and a display panel 140. In this embodiment, the lens 130 is disposed on a first side of the tube 110 adjacent to a target area TG. The display panel 140 is disposed on a second side of the tube 110 away from the target area TG. The first side is opposite to the second side.

On the other hand, the light beam generator LE1 includes two partial light beam generators LE11 and LE12. Each of the partial light beam generators LE11 and LE12 of the light beam generator LE1 may include one or more light emitting diodes. In this embodiment, said light emitting diode may be an infrared emitting diode. The light beam generators LE11 and LE12 are respectively disposed on an upper edge and a lower edge of the lens 130 and respectively project light beams B11 and B12 to surrounding ranges R11 and R12 of the target area TG.

In addition, the light beam generator LE2 is disposed inside the tube 110 and configured to project a light beam B2. In this embodiment, a reflector 150 is disposed in the tube 110. Through the reflector 150, the light beam generator LE2 may have the light beam B2 reflected and then projected to a center range R2 of the target area TG. The light beam generator LE2 includes one or more light emitting diodes, which may be infrared emitting diode(s). The reflector 150 may be an infrared reflector.

The image capturer C1 may be an infrared camera. The image capturer C1 is disposed inside the tube 110, and captures image information of the target area TG through the reflector 150. The image capturer C1 is coupled to the controller 120, and configured to transmit image information IF to the controller 120. The controller 120 may then analyze the image information IF. When an eyeball EYE of a user is located on the target area TG, the controller 120 may perform a tracking operation on the eyeball EYE according to the image information IF.

In this embodiment, the controller 120 may be a processor with computing capability. Alternatively, the controller 120 may be a hardware circuit designed through Hardware Description Language (HDL) or any other design methods for digital circuit well-known to persons with ordinary skill in the art and may be implemented in from of Field Programmable Gate Array (FPGA), Complex Programmable Logic Device (CPLD) or Application-specific Integrated Circuit (ASIC).

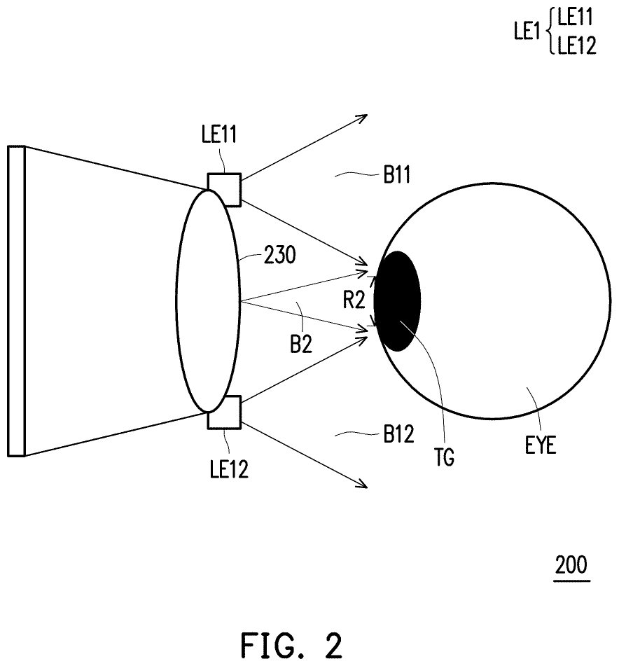

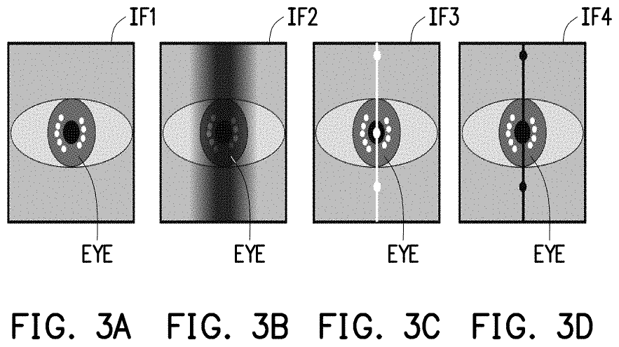

For operation details of the head mounted display in the embodiment of the invention, reference can be made to the schematic diagram of a head mounted display of the embodiment of the invention illustrated in FIG. 2 and the schematic diagrams of a supplementary lighting operation of the embodiment of the invention illustrated in FIG. 3A to FIG. 3D. In FIG. 2, an image capturer in a head mounted display 200 may perform an image capturing operation on the eyeball EYE on the target area, and in an ideal state, may obtain image information IF1 as shown in FIG. 3A.

When the eyeball EYE of the user is too close to a lens 230 of the head mounted display 200, a range covered by light beams projected by the beam generators LE11 and LE12 disposed at edges of the lens 230 cannot effectively cover the center range R2 of the target area on which the eyeball EYE is located. In this case, the image capturer in the head mounted display 200 may perform the image capturing operation on the eyeball EYE on the target area, and may obtain image information IF2 as shown in FIG. 3B. In the image information IF2, as can be clearly seen, it is difficult to recognize a light spot on the eyeball EYE of the user because the brightness is too low at a part of the eyeball EYE.

In this embodiment of the invention, the head mounted display 200 can turn on the light beam generator disposed inside the tube to project the light beam B2, and perform the supplementary lighting operation for the center range R2 of the target area through the light beam B2. After the light beam B2 is generated, the head mounted display 200 may capture image information IF3, wherein the brightness at the part of the eyeball EYE in the image information IF3 has been increased.

Incidentally, in the image information IF3, a stray light may be generated on the eyeball EYE due to the lens 230.

Next, in FIG. 3D, the controller of the head mounted display 200 may perform a stray light eliminating operation for the image information IF3, and accordingly obtain image information IF4. Further, the controller may determine a location of the eyeball EYE through a light spot on the eyeball in image information IF4.

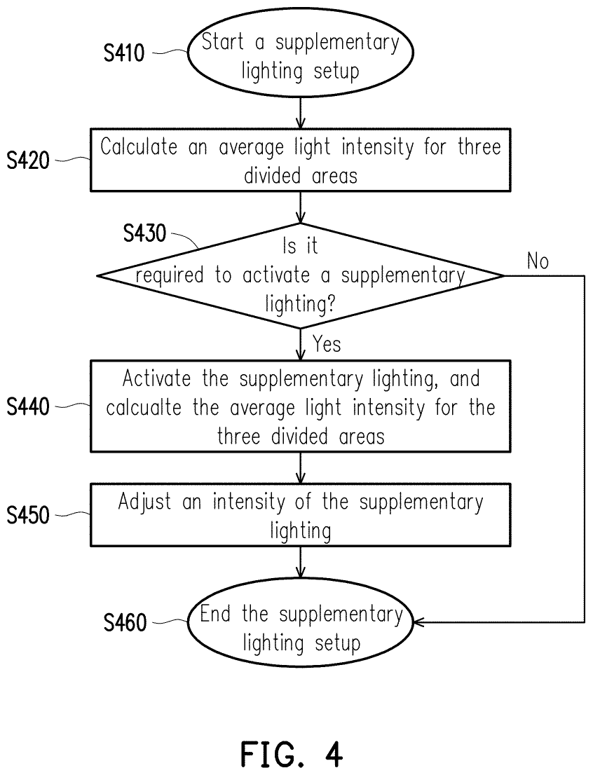

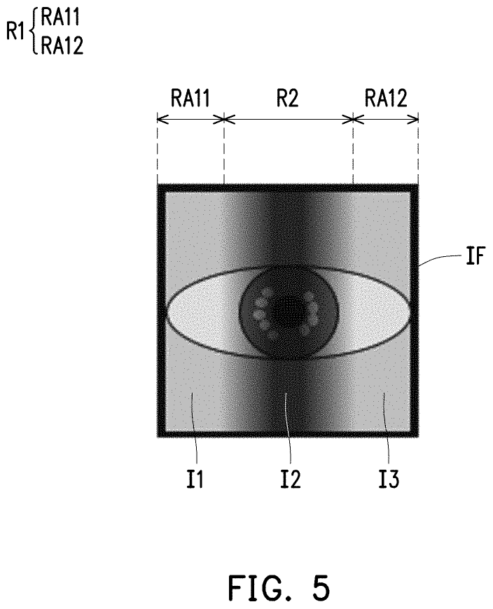

The following refers to FIG. 1 and FIG. 4 together, and FIG. 4 illustrates a flowchart of the supplementary lighting of the head mounted display in an embodiment of the invention. Here, in step S410, a supplementary lighting setup is started. At this time, in the head mounted display 100, the light beam generator LE2 disposed inside the tube 110 for projecting the light beam B2 to the center range R2 of the target area TG is not turned on. Instead, only the light beam generators LE11 and LE12 for projecting the light beams B11 and B12 to the surrounding ranges R11 and R12 of the target area TG are turned on. Next, in step S420, three areas are divided according to image information, and a light intensity in image information is calculated. Details of the above may refer to FIG. 1, FIG. 4 and FIG. 5 together, and FIG. 5 illustrates a schematic diagram of image information in an embodiment of the invention. In FIG. 5, according to the location of the image information IF, the controller 120 may divide the image information IF into the center range R2 and a surrounding range R1 including two sub ranges RA11 and RA12. Here, the center range R2 is between the sub ranges RA11 and RA12. In step S420, the controller 120 may calculate an average light intensity of the center range R2 to obtain an average brightness I2, and calculate average light intensities of the sub ranges RA11 and RA12 to obtain sub brightnesses I1 and I3. Further, the controller 120 may calculate a ratio of twice the average brightness I2 to a sum of the sub brightnesses I1 and I3 (=(2*I2)/(I1+I3)), and determine whether to activate the supplementary lighting operation according to whether the above ratio is less than a preset threshold (step S430).

In step S430, when the ratio is less than the preset threshold, the controller 120 may activate the supplementary lighting operation, turn on the light beam generator LE2 disposed inside the tube 110 to project the light beam B2 for a supplementary lighting to the center range R2 of the target area TG, and proceed to execute step S440. On the contrary, if the ratio is not less than the preset threshold, it is not required to start the supplementary lighting operation, and the supplementary lighting setup may be ended (step S460). The preset threshold of this embodiment may be 80%.

In step S440, the image capturer C1 may perform the image capturing operation on the target area TG again, and the controller 120 may then calculate the ratio of the average brightness of the center range R2 to the average brightnesses of the sub ranges RA11 and RA12 according to new image information. Next, in step S450, the controller 120 performs a brightness adjusting operation on the light beam for the supplementary lighting according to a size of the updated ratio (step S450). In an embodiment of the invention, when the updated ratio is less than 80%, it means that the brightness of the light beam for the supplementary light needs to be increased. On the other hand, when the updated ratio is greater than 120%, it means that the brightness of the light beam used for the supplementary light needs to be reduced. Corresponding to the above, the controller 120 may send a command to drive the light beam generator LE2 to adjust a light intensity (brightness) of the light beam B2.

In the operation of comparing the ratio with 80% and 120%, the values of 80% and 120% are only illustrative examples and are not intended to limit the scope of the invention. Those with ordinary knowledge in this field can set the comparison basis of the ratio according to the actual needs, and there are no specific restrictions.

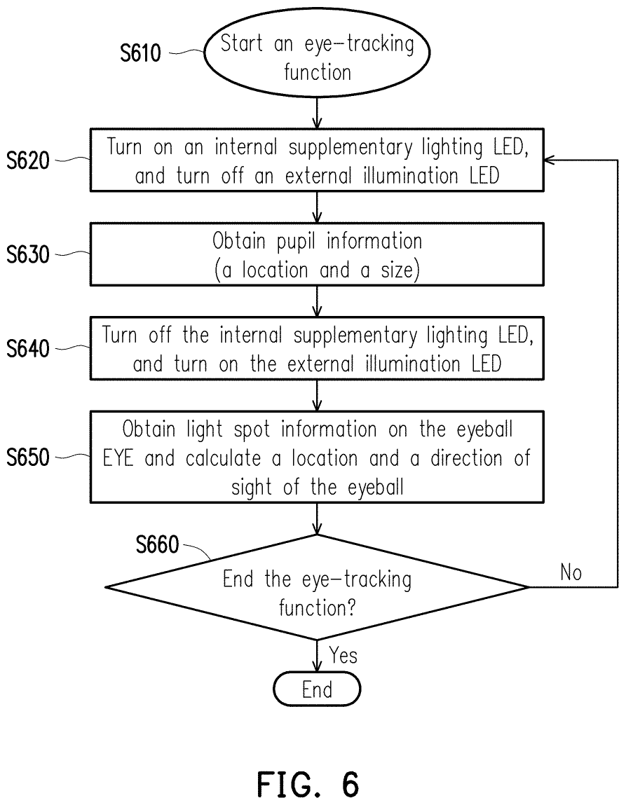

The following refers to FIG. 1 and FIG. 6 together, and FIG. 6 illustrates a flowchart of the eye-tracking function of the head mounted display in an embodiment of the invention. In step S610, an eye-tracking function is started. Next, in step S620, the head mounted display 100 may turn on the light beam generator (light emitting diode LED) LE2 disposed inside the tube 110 for the supplementary lighting operation, and turn off the light beam generators (light emitting diode LED) LE11 and LE12 disposed outside the tube 110 for illumination. Next, in step S630, the image capturer C1 captures image information of the eyeball EYE in the target area TG. The controller 120 may calculate pupil information (a location and a size of the pupil) according to the image information of the center range that is lit.

Next, in step S640, the head mounted display 100 may turn off the light beam generator (light emitting diode LED) LE2 disposed inside the tube 110, and turn on the light beam generators (light emitting diode LED) LE11 and LE12 disposed outside the tube 110. In step S650, by capturing the image information of the eyeball EYE, light spot information on the eyeball EYE is obtained and a location and a direction of sight of the eyeball are calculated.

In step S660, whether to end the eye-tracking operation is determined. If the eye-tracking operation is not to be ended, step S620 is executed again. The determination of step S660 may be based on whether an eye-tracking requirement of the head mounted display 100 is ended, and the entire process may be ended when the head mounted display 100 no longer needs to track the location of the eyeball of the user.

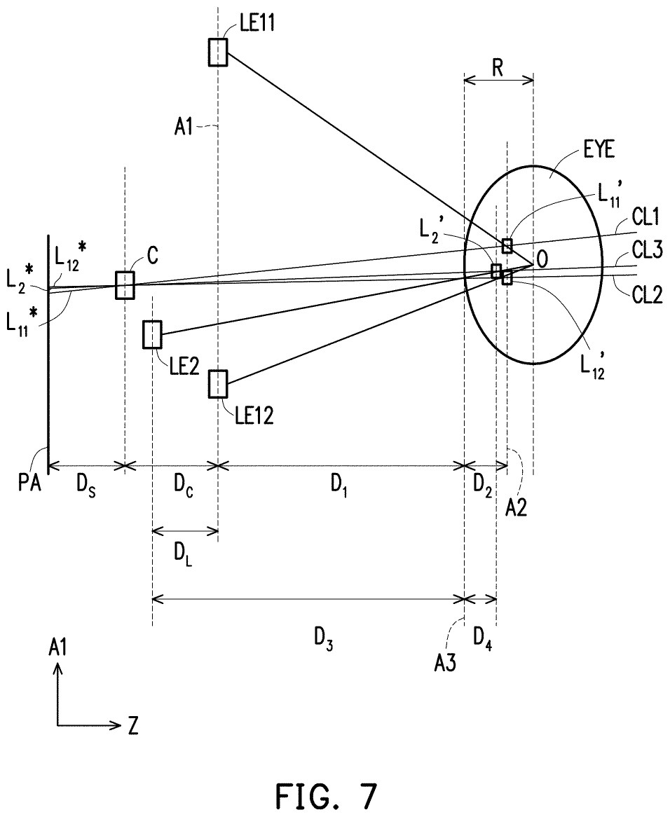

More specifically, the head mounted display of the invention may further calculate the curvature of the cornea of the eyeball of the user and a distance between the eyeball and the lens according to the captured image information. Referring to FIG. 7, FIG. 7 illustrates a schematic diagram of a calculating method for the curvature of the cornea of the eyeball and the distance between the eyeball and the lens. In FIG. 7, in the image capturer, a distance D_{S} is provided between a light center C of the image capturer and a screen PA; a shortest distance D_{C} is provided between a connecting line A1 of the light beam generators LE11 and LE12 disposed outside the tube and the light center C; and a shortest distance D_{L} is provided between the light beam generator LE2 disposed inside the tube and the connecting line A1. Here, because the light beam generator LE2 is not coplanar with the light beam generators LE11 and LE12, the distance D_{L} is not equal to 0. The image information may be generated on the screen PA, and the image information includes light spot images L₁₁*, L₁₂* and L₂*. The light spot images L₁₁*, L₁₂* and L₂* respectively correspond to light spots generated on the eyeball EYE by the light beams provided by the light beam generators LE11 and LE12 and the light beam generator LE2. The aforementioned distances D_{S}, D_{C} and D_{L} are all known and fixed parameters.

On the other hand, the cornea of the eyeball EYE is spherical and has a radius of curvature R and a spherical center O. A shortest distance D₁ is provided between the eyeball EYE and the connecting line A1 of the light beam generators LE11 and LE12 (which is equal to a distance between a spherical tangent A3 of the eyeball EYE and the connecting line A1). Further, the light beams provided by the light beam generators LE11, LE12 and LE2 may be imaged on different locations L₁₁′, L₁₂′ and L₂′ in the eyeball EYE. Here, the locations L₁₁′ and L₁₂′ are not coplanar with the location L₂′. In addition, a shortest distance D₂ is provided between a connecting line A2 of the locations L₁₁′ and L₁₂′ and the tangent A3; a shortest distance D₄ is provided between the location L₂′ and the tangent A3; and a shortest distance D₃ is provided between the tangent A3 and the light beam generator LE2. The above distances D₁ to D₄ are all variable parameters.

In this embodiment of the invention, the radius of curvature R of the cornea and the distance D₁ may be calculated through an imaging formula. First, a hypothetical plane is set, and the hypothetical plane is parallel to the connecting line A1 and perpendicular to a Z axis. Next, the connecting line A2 is positioned on FIG. 7. A first connecting line CL1 is generated according to the light center C and the light spot image L₁₁*, and a second connecting line CL2 is generated according to the light center C and the light spot image. Accordingly, an intersection (the location L₁₁′) between the first connecting line CL1 and the connecting line A2 and an intersection (the location L₁₂′) between the second connecting line CL2 and the connecting line A2 are calculated. The spherical center O is an intersection between a connecting line of the location LE11 and the location L₁₁′ and a connecting line of the location LE12 and the location L₁₂′.

A shortest distance between the spherical center O and the connecting line A2 may be equal to the radius of curvature R minus the distance D₂. A shortest distance between the connecting lines A1 and A2 is equal to the distance D₁+the distance D₂. According to the imaging formula, a mathematical formula may be obtained as: 1/D₁+1/D₂=2/R. By solving the simultaneous equations for the above relationship, the distances D₁ and D₂ and the radius of curvature R may be calculated.

Then, a third connection CL3 is generated according to the light center C and the light spot image L₂* and an intersection between a connecting line of the spherical center O and the light beam generator LE2 and the connecting line CL3 is calculated to obtain the location L₂′. Here, the distance D₃=the distance D_{L}+the distance D₁, and the distance D₄ may be obtained according to the imaging formula: 1/D₃+1/D₄=2/R.

Because the connecting line A2 based on the above is hypothetical at the beginning of the calculation and is not necessarily set at the correct position, a further verification need to be performed. Here, a vector is generated according to the location L₂′ and the spherical center O, and an inner product operation is performed on this vector and the Z axis. The result of the operation is subtracted (the radius of curvature R−the distance D₄) to generate an error value. When the error value is not equal to 0 or greater than a tolerance value, the location of the connecting line A2 may be adjusted and the aforesaid operation may be performed to obtain the new distances D₁ to D₄ and the radius of curvature R until the error value is equal to 0 or less than the tolerance value.

In this way, the head mounted display of this embodiment of the invention can effectively calculate the curvature of the cornea of the eyeball and the distance between the eyeball and the lens, thereby improving the efficiency of eye-tracking.

The above calculation of the curvature of the cornea of the eyeball and the distance between the eyeball and the lens using the imaging formula are only examples for illustration, and do not limit the scope of the present invention. The head mounted display of this embodiment of the invention may also use other calculation methods to obtain the curvature of the cornea of the eyeball and the distance between the eyeball and the lens.

In summary, according to the invention, different light beam generators are provided inside and outside a case of the head mounted display, and the light beam generators project the light beams to the surrounding range and the center range of the target area during the eye-tracking operation, respectively. As a result, all ranges in the target area can have sufficiently high brightness so that the eye-tracking operation may be effectively performed.

What is claimed is:

1. A head mounted display, comprising:
a tube;
a first light beam generator, disposed outside the tube, and projecting a plurality of first light beams to a first range of a target area;
a second light beam generator, disposed inside the tube, and projecting a second light beam to a second range of the target area;
an image capturer, capturing an image on the target area to generate image information; and
a controller, receiving the image information, and performing an eye-tracking operation according to the image information,
wherein the second range is a center range of the target area, and the first range is a surrounding range of the target area.

2. The head mounted display according to claim 1, wherein in a first time interval:
the first light beam generator projects the first light beams to the first range of the target area;
the image capturer captures the image on the target area to generate first image information; and
the controller respectively calculates a first average brightness and a second average brightness of the first range and the second range according to the first image information, and determines whether to drive the second light beam generator to project the second light beam according to the first average brightness and the second average brightness.

3. The head mounted display according to claim 2, wherein in a second time interval subsequent to the first time interval:
when a ratio of the second average brightness to the first average brightness is less than a threshold, the controller drives the second light beam generator to project the second light beam;
the image capturer captures the image on the target area to generate second image information; and
the controller calculates location information of an eyeball on the target area according to the second image information.

4. The head mounted display according to claim 3, further comprising:
when the ratio of the second average brightness to the first average brightness is less than the threshold and the second light beam generator is turned on, the second light beam generator increases a brightness of the second light beam.

5. The head mounted display according to claim 4, wherein in the first time interval, the first light beam generator projects the first light beams to a first sub range and a second sub range of the first range; the controller obtains a first sub brightness I1 and a second sub brightness I3 respectively corresponding to the first sub range and the second sub range; and the controller calculates a ratio of twice the second average brightness I2 to a sum of the first sub brightness I1 and the second sub brightness I3=(2*I2)/(I1+I3).

6. The head mounted display according to claim 5, wherein the brightness of the second light beam is increased when the ratio is less than 80%.

7. The head mounted display according to claim 5, wherein when the ratio is greater than 120%, the second light beam generator reduces the brightness of the second light beam.

8. The head mounted display according to claim 1, wherein in a first time interval:
the second light beam generator projects the second light beam to the second range of the target area; the first light beam generator is turned off;
the image capturer captures the image on the target area to generate first image information; and
the controller calculates pupil information of an eyeball in the target area according to the first image information; and
in a second time interval different from the first time interval:
the first light beam generator projects the first light beams to the first range of the target area; the second light beam generator is turned off;
the image capturer captures the image on the target area to generate second image information; and
the controller calculates a location and a direction of sight of the eyeball in the target area according to the first image information.

9. The head mounted display according to claim 1, further comprising:
a lens, disposed on a first side of the tube adjacent to the target area; and
a reflector, disposed in the tube, and configured to reflect the second light beam to the target area,
wherein the first light beam generator is disposed on an edge of the lens, and the image capturer captures the image information of the target area through the reflector.

10. The head mounted display according to claim 9, wherein the controller further calculates a curvature of a cornea of an eyeball and a distance between the eyeball and the lens according to the image information.

11. The head mounted display according to claim 9, further comprising:
a display panel, disposed on a second side of the tube opposite to the first side.

12. The head mounted display according to claim 1, wherein the first light beam generator comprises a plurality of first infrared transmitters; the second light beam generator comprises a plurality of second infrared transmitters; and the image capturer is an infrared camera.
